(19) United States
(12) Patent Application Publication
(10) Pub. No.: US 2008/0252650 A1
(43) Pub. Date: Oct. 16, 2008

(54) Organic light emitting display, driver system therfor and driving method thereof

(76) Inventors: Do-hyung Ryu, Suwon-si (KR); Do-ik Kim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/078,982

(22) Filed: Apr. 9, 2008

(30) Foreign Application Priority Data
Apr. 10, 2007 (KR) 10-2007-0035010

(51) Int. Cl. G09G 5/36; H01J 1/62

(52) U.S. Cl. 345/545; 313/504

(57) ABSTRACT

The organic light emitting display may include a scan driver configured to sequentially supply a scan signal to scan lines during every subframe period, a data driver configured to supply a data signal to data lines when the scan signal is supplied, at least one lookup table configured to store a gamma correction value to gamma-correct data input from the outside, and a frame memory arranged between the lookup table and the data driver to store the gamma-corrected data.

### BACKGROUND OF THE INVENTION

1. Field of the Invention

Embodiments relate to an organic light emitting display, a driving system therefore, and a driving method thereof. More particularly, embodiments relate to an organic light emitting display operating in a digital driving mode while minimizing a required memory capacity, a driving system therefor, and a driving method thereof.

2. Description of the Related Art

A variety of flat panel displays having reduced weight and volume compared to a cathode ray tube have recently been developed. Flat panel displays include a liquid crystal display (LCD), a field emission display (FED), a plasma display panel (PDP), an organic light emitting display, etc.

Organic light emitting displays use organic light emitting diodes (OLEDs) to display an image. The OLEDs generate light by recombination of electrons and holes. Organic light emitting displays provide a rapid response time and a low power consumption.

Subpixels in organic light emitting displays may include an OLED and a pixel circuit, coupled to a data line and a scan line, to control the OLED. The pixel circuit may include transistors and a storage capacitor, using the storage capacitor to store voltages according to data signals from the data line when operating in an analog driving mode.

However, such pixel circuits may have difficulty accurately displaying an image having a desired grey level, since a voltage stored in the storage capacitor is used to display grey levels. In particular, such pixel circuits may have difficulty accurately representing a brightness difference between adjacent grey levels, since a certain voltage stored in the storage capacitor may be used to represent more than one grey level. Further, if the deviations in threshold voltage and electrons mobility of transistors in the pixel circuit are present in the subpixels, light having different grey levels may be generated for the same grey level voltage, and thereby make it difficult to display an image having uniform luminance.

### SUMMARY OF THE INVENTION

Embodiments are therefore directed to an organic light emitting display, a driving system therefor, and a driving method thereof, which substantially overcomes one or more of the problems due to the limitations and disadvantages of the related art.

It is therefore a feature of an embodiment to provide an organic light emitting display capable of applying to a digital driving mode while minimizing a required memory capacity, a driving system therefor, and a driving method thereof.

At least one of the above and other features and advantages may be realized by providing an organic light emitting display which divides one frame into a plurality of subframes and drives the subframes, including a scan driver configured to sequentially supply a scan signal to scan lines during every subframe period, a data driver configured to supply a data signal to data lines when the scan signal is supplied, at least one lookup table configured to store a gamma correction value to gamma-correct data input from the outside, and a frame memory arranged between the lookup table and the data driver to store the gamma-corrected data.

The at least one lookup table may include a red lookup table configured to store a gamma correction value for red data, a green lookup table configured to store a gamma correction value for green data, and a blue lookup table configured to store a gamma correction value for blue data.

The organic light emitting display may further include a storage unit between the lookup table and the frame memory, the storage unit being configured to store data of one line and transmit the stored data to the frame memory.

The data driver may be configured to generate a data signal using the gamma-corrected data input from the frame memory. The data driver may include a shift register unit configured to sequentially generate a sampling signal, a sampling latch unit configured to sequentially input the gamma-corrected data when the sampling signal is output from the shift register unit, a holding latch unit configured to input the gamma-corrected data stored in the sampling latch unit at the same time, a digital-analog converter configured to generate a data signal using the gamma-corrected data stored in the holding latch unit, and a buffer unit configured to transmit the data signal to the data lines.

The scan lines and data lines may intersect and subpixels may be arranged at intersections of the scan lines and the data lines.

The organic light emitting display may further include a timing controller configured to receive the data and synchronizing signals input from the outside. The look-up table and the frame memory may be part of the timing controller.

At least one of the above and other features and advantages may be realized by providing a method for driving an organic light emitting display, the method including gamma-correcting data, input from the outside, using a gamma correction value stored in at least one lookup table, storing the gamma-corrected data in a frame memory, and generating a data signal using the gamma-corrected data stored in the frame memory.

Gamma-correcting data may include gamma-correcting red data, gamma-correcting green data, and gamma-correcting blue data.

The method may further include storing the gamma-corrected data of one line in a storage unit, and transmitting the gamma-corrected data of one line, stored in the storage unit, to the frame memory.

At least one of the above and other features and advantages may be realized by providing a driving system for use in driving an organic light emitting display, the device including at least one lookup table configured to store a gamma correction value, receive data from outside, and output gamma-corrected data, a frame memory configured to store the gamma-corrected data, and a data driver configured to generate a data signal using the gamma-corrected data stored in the frame memory.

The at least one lookup table may include a red lookup table configured to store a gamma correction value for red data, a green lookup table configured to store a gamma correction value for green data, and a blue lookup table configured to store a gamma correction value for blue data.

The driving system may further include a storage unit between the lookup table and the frame memory, the storage unit being configured to store data of one line and transmit the stored data to the frame memory.

The driving system may further include a timing controller configured to receive the data and synchronizing signals input from the outside. The at least one look-up table and the frame memory may be included in the timing controller.

The data driver may include a shift register unit configured to sequentially generate a sampling signal, a sampling latch unit configured to sequentially input the gamma-corrected data when the sampling signal is output from the shift register unit, a holding latch unit configured to input the gamma-corrected data stored in the sampling latch unit at the same time, a digital-analog converter configured to generate a data signal using the gamma-corrected data stored in the holding latch unit, and a buffer unit configured to transmit the data signal to the data lines.

The driving system may include a scan driver configured to sequentially supply a scan signal to scan lines during every subframe period.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a block diagram of an organic light emitting display according to an embodiment of the present invention;

FIG. 2 illustrates a diagram of one frame of the organic light emitting display according to an embodiment of the present invention;

FIG. 3 illustrates a diagram of a first embodiment of a timing controller and the data driver shown in FIG. 1;

FIG. 4 illustrates a diagram of a second embodiment of a timing controller and the data driver shown in FIG. 1;

FIG. 5 illustrates a diagram of a third embodiment of a timing controller and the data driver shown in FIG. 1; and

FIG. 6 illustrates a diagram of a fourth embodiment of a timing controller and the data driver shown in FIG. 1.

### DETAILED DESCRIPTION OF THE INVENTION

Korean Patent Application No. 10-2007-0035010, filed on Apr. 10, 2007, in the Korean Intellectual Property Office, and entitled: “Organic Light Emitting Display and Driving Method Thereof” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

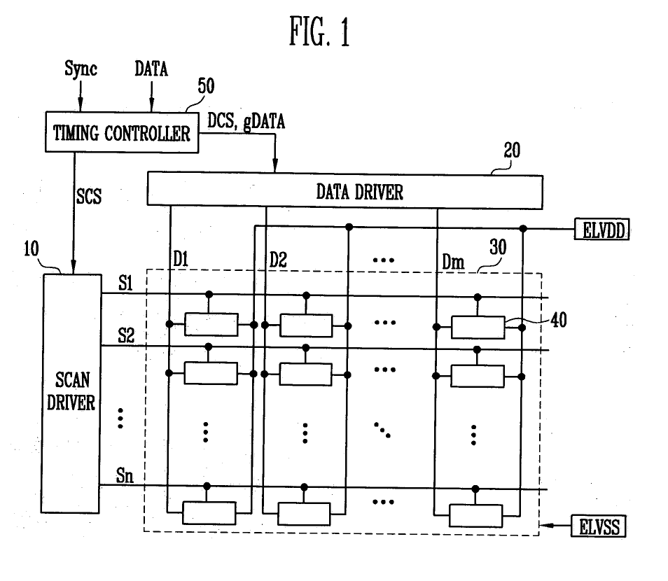

FIG. 1 illustrates a block diagram of an organic light emitting display according to an embodiment of the present invention.

Referring to FIG. 1, the organic light emitting display may include a pixel unit 30, including a plurality of subpixels 40 coupled to scan lines (S1 to Sn) and data lines (D1 to Dm), a scan driver 10 for driving the scan lines (S1 to Sn), a data driver 20 for driving the data lines (D1 to Dm), and a timing controller 50 for controlling the scan driver 10 and the data driver 20.

The timing controller 50 may generate a data drive control signal (DCS) and a scan drive control signal (SCS) in accordance with synchronizing signals (SYNC) supplied from the outside. The data drive control signal (DCS) may be supplied to the data driver 20, and the scan drive control signal (SCS) may be supplied to the scan driver 10. The timing controller 50 may also receive data (DATA) from the outside, gamma-correct the received data (DATA), and supply the gamma-corrected data (gDATA) to the data driver 20. For such gamma correction, the timing controller 50 may include at least one lookup table (not shown).

The data driver 20 may convert the data (DATA) from the timing controller 50 into a data signal, and supply the converted data signal to the data lines (D1 to Dm) during a plurality of subframe periods in one frame. The data signal may be divided into a first data signal allowing the subpixel 40 to emit light and a second data signal preventing the subpixel 40 from emitting light. In other words, the data driver 20 may supply the first data signal and/or second data signal to the data lines (D1 to Dm), wherein the first data signal and/or second data signal controls whether the subpixel 40 emits light when a scan signal is supplied during each of the subframe periods.

The scan driver 10 may sequentially supply a scan signal to the scan lines (S1 to Sn) during each of the subframe periods. If the scan signal is sequentially supplied to the scan lines (S1 to Sn), then the subpixels 40 may be sequentially selected by line. At this time, the subpixels 40 selected by the scan signal may receive a first data signal or a second data signal from the data lines (D1 to Dm).

The pixel unit 30 may receive a first voltage VDD from a first power source (ELVDD) and a second voltage VSS from a second power source (ELVSS) from the outside, and supply the first power voltage VDD and the second power voltage VSS to each of the subpixels 40. Each of the subpixels 40 receiving the first power voltage VDD and the second power voltage VSS may receive a first data signal or a second data signal when a scan signal is supplied, and may emit or not emit light during each of the subframe periods in accordance with the received data signal. For example, when the scan signal is supplied, subpixels 40 receiving the first data signal emit light during a corresponding subframe period, and subpixels 40 receiving the second data signal do not emit light during a corresponding subframe period.

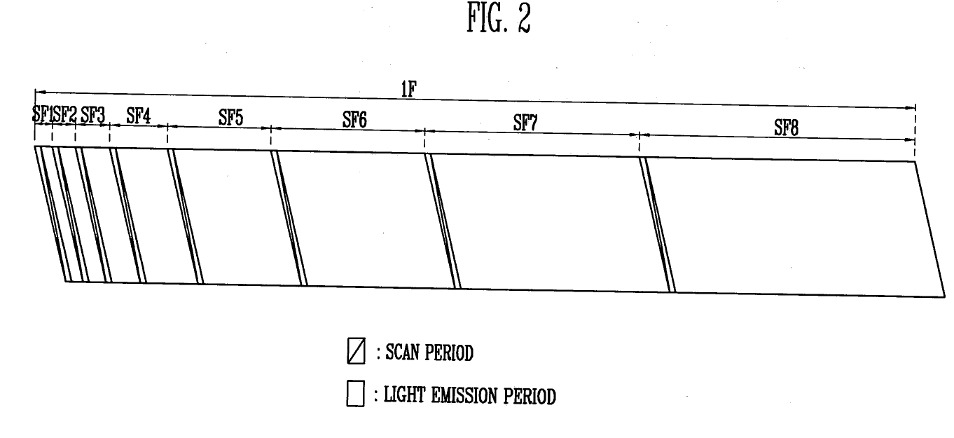

FIG. 2 illustrates a schematic diagram of one frame of the organic light emitting display according to an embodiment of the present invention.

Referring to FIG. 2, one frame (1 F) may be divided into a plurality of subframes (SF1 to SF8), and the subframes may be driven, e.g., in a digital driving mode. Each of the subframes (SF1 to SF8) may be divided into a scan period and a light emission period.

During the scan period, the scan signal may be sequentially supplied to the scan lines (S1 to Sn), and a first data signal or a second data signal may be supplied to the data lines (D1 to Dm). Thus, the subpixels 40 may receive the first data signal or the second data signal during the scan period.

During the light emission period, each of the subpixels 40 may emit or not emit light in accordance with the first data signal or the second data signal supplied during the scan period. In other words, the subpixels 40 receiving the first data signal during the scan period may emit light during a corresponding subframe period, and the subpixels 40 receiving the second data signal may not emit light during a corresponding subframe period.

The light emission periods may be set to different levels in each of the subframes (SF1 to SF8). For example, if an image is displayed with 256 grey levels, one frame may be divided into eight subframes (SF1 to SF8). In each of the eight subframes (SF1 to SF8), the light emission period may be increased at a rate of 2ⁿ (n=0, 1, 2, 3, 4, 5, 6, 7). Each subframe may control the subpixels 40 to display an image having a predetermined grey level. In other words, the sum of the time when the subpixels are allowed to emit the light during a subframe period is used to display an image having a predetermined grey level during one frame period.

The particular frame shown in FIG. 2 is one example, and the present invention is not limited thereto. For example, one frame may be divided into at least ten subframes, and the light emission period in each of the subframes may be widely varied by a designer. Each of the subframes may further include a reset period, in addition to the scan period and the light emission period. The reset period may be used to set the subpixels 40 to a reset state.

Such a digital driving mode may accurately represent a desired grey level, since the light emission time of the subpixels is used to represent grey levels, rather than dividing a certain voltage to represent grey levels. Also, an image having a uniform luminance may be displayed regardless of the nonuniformity of transistors, since an ON or OFF state of the transistor in each of the subpixels 40 may be used to represent grey levels.

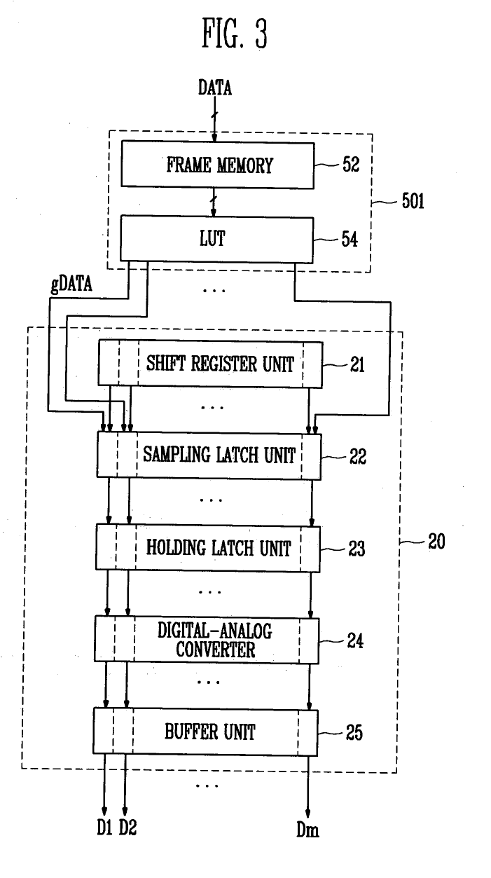

FIG. 3 illustrates a diagram of a first embodiment of a timing controller 501 and the data driver 20 as shown in FIG. 1. As shown in FIG. 3, the timing controller 501 may receive data (DATA) and transmit the received data (DATA) as gamma-corrected data (gDATA) to the data driver 20, and the data (DATA) may be 8-bit data. However, embodiments are not limited thereto.

Referring to FIG. 3, the data driver 20 may include a shift register unit 21, a sampling latch unit 22, a holding latch unit 23, a digital-analog converter 24, and a buffer unit 25.

The shift register unit 21 may sequentially generate a sampling signal and supply the generated sampling signal to the sampling latch unit 22. The sampling latch unit 22 may sequentially receive the gamma-corrected data (gDATA) when a sampling signal is input from the shift register unit 21. The holding latch unit 23 may receive the gamma-corrected data (gDATA) stored in the sampling latch unit 22 at the same time, and may supply the gamma-corrected data (gDATA) to the digital-analog converter 24. The digital-analog converter 24 may convert the gamma-corrected data (gDATA) into a first data signal or a second data signal, and supply the first data signal or the second data signal to the buffer unit 25. The buffer unit 25 may supply the first data signal or the second data signal to the data lines (D1 to Dm).

The timing controller 501 may include a frame memory 52 and at least one lookup table (hereinafter, referred to as “LUT”) 54. The frame memory 52 may store the data (DATA) input from the outside. For example, a data of one frame input from the outside may be stored in the frame memory 52.

The LUT 54 may store gamma correction values for the data (DATA). In other words, the data (DATA) stored in the frame memory 52 may be gamma-corrected by the gamma correction values in the LUT 54, and may be supplied to the data driver 20 as the gamma-corrected data (gDATA).

When the LUT 54 is between the frame memory 52 and the data driver 20, a required memory capacity of the LUT 54 may be increased. More particularly, because one frame is generally divided into subframes and the subframes are driven in the digital driving mode, one frame is driven at a high driving frequency as compared to the analog driving mode. In order to reduce the driving frequency, the data (DATA) may be transmitted between the frame memory 52 and the LUT 54 by one unit of a plurality of pixels, where one pixel may include a red subpixel, a green subpixel and a blue subpixel, or one line unit.

Thus, a capacity of the LUT 54 may correspond to one unit of a plurality of pixels or one line unit. If the data (DATA) is transmitted by one unit of 4 pixels, then the LUT 54 may need a 3 Kbyte capacity (4×3 (R,G,B)×256 byte=3 Kbyte). If the data (DATA) is transmitted by one line unit, then the LUT 54 requires even more memory capacity. If the LUT 54 is arranged between the frame memory 52 and the data driver 20, the capacity of the LUT 54 may be changed to correspond to a transmission unit of the data (DATA) between the frame memory 52 and the LUT 54.

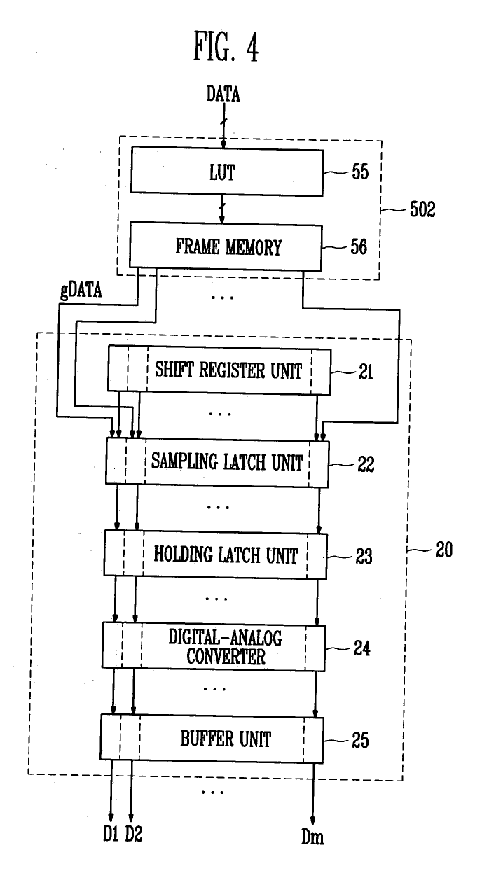

FIG. 4 illustrates a diagram of a second embodiment of a timing controller 502 and the data driver 20 as shown in FIG. 1. In the case of FIG. 4, detailed description that is the same as that in FIG. 3 will not be repeated.

Referring to FIG. 4, the timing controller 502 may include a LUT 55 and a frame memory 56. The LUT 55 may receive data (DATA) from the outside, gamma-correct the received data (DATA), and supply the gamma-corrected data (gDATA) to the frame memory 56. The frame memory 56 may store the gamma-corrected data (gDATA) supplied from the LUT 55. For example, the gamma-corrected data (gDATA) of one frame may be stored in the frame memory 56. The gamma-corrected data (gDATA) stored in the frame memory 56 may be supplied to the data driver 20 and converted into a data signal supplied to the data lines D1 to Dm.

In the second embodiment of the present invention, the LUT 55 may be before the frame memory 56. Thus, the capacity of the LUT 55 may be minimized regardless of the data transmission system of the frame memory 56 and the data driver 20. In practice, one each of red data, green data and blue data may be input from the outside. Accordingly, the capacity of the LUT 55 may have a capacity corresponding to one pixel, e.g., 0.77 Kbyte (3 (R,G,B)×256 byte).

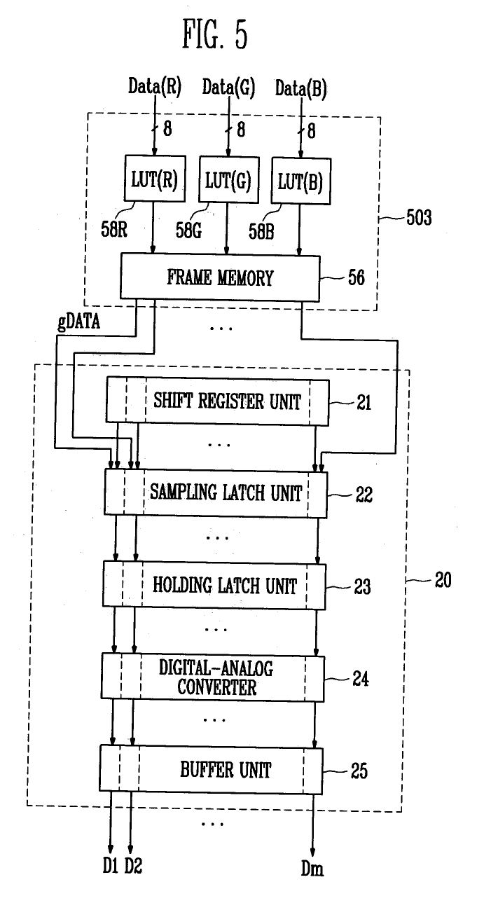

While only one LUT 55 is shown in FIG. 4, three LUTs may be provided to correspond to each of the red data (DATA (R)), the green data (DATA (G)) and the blue data (DATA (B)), as illustrated in a third embodiment of a timing controller 503 illustrated in FIG. 5. In particular, the timing controller 503 may include a read LUT 58R, a green LUT 58G, a blue LUT 58B, and the frame memory 56.

The red LUT (58R) may receive red data (DATA (R)) from the outside, gamma-correct the received red data (DATA (R)), and supply the gamma-corrected red data (gDATA (R)) to the frame memory 56. The green LUT (58G) may receive green data (DATA (G)) from the outside, gamma-correct the received green data (DATA (G)), and supply the gamma-corrected green data (gDATA (G)) to the frame memory 56. The blue LUT (58B) may receive blue data (DATA (B)) from the outside, gamma-correct the received blue data (DATA (B)), and supply the gamma-corrected blue data (gDATA (B)) to the frame memory 56.

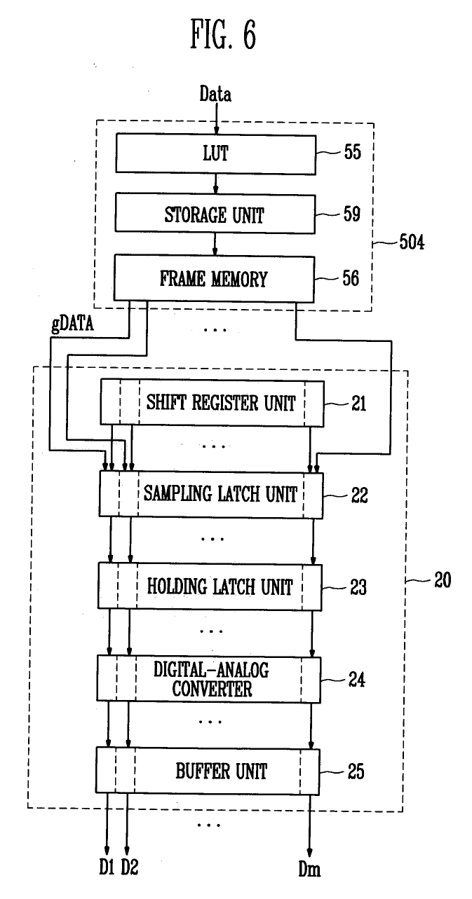

FIG. 6 illustrates a diagram of a fourth embodiment of a timing controller 504 and the data driver 20 as shown in FIG. 1. In the case of FIG. 6, detailed description that is the same as that in FIGS. 3 and 4 will not be repeated.

As illustrated in FIG. 6, the timing controller 504 may include a storage unit 59 between the LUT 55 and the frame memory 56. The storage unit 59 may sequentially store the gamma-corrected data (gDATA) output from the LUT 55, e.g., may store of the gamma-corrected data (gDATA) of one line, and supply the stored gamma-corrected data (gDATA) of one line to the frame memory 56. Thus, the gamma-corrected data (gDATA) may be stored in the frame memory 56 by line unit. In this case, a driving frequency may be reduced as compared to directly transmitting the gamma-corrected data (gDATA) from the LUT 55 to the frame memory 56. The storage unit 59 may be configured with shift registers, etc., so the gamma-corrected data (gDATA) of one line may be stored.

FIG. 3 to FIG. 6 show that a LUT and a frame memory are included in a timing controller in accordance with embodiments, but the present invention is not limited thereto. For example, the LUT and the frame memory may be external the timing controller.

As described above, the organic light emitting display according to embodiments of the present invention and the driving method thereof may allow a capacity of the LUT to be minimized when the organic light emitting display is driven in a digital driving mode by installing the LUT prior to the frame memory. The organic light emitting display according embodiments may also maintain the capacity of the LUT at a constant level regardless of the data transmission unit of the frame memory and the data driver. Further, the organic light emitting display according to embodiments may display a uniform image regardless of the deviation in the drive transistor and may accurately represent a desired grey level, since the organic light emitting display is driven in a digital driving mode.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An organic light emitting display that divides one frame into a plurality of subframes and drives the subframes, comprising:
a scan driver configured to sequentially supply a scan signal to scan lines during every subframe period;
a data driver configured to supply a data signal to data lines when the scan signal is supplied;
at least one lookup table configured to store a gamma correction value to gamma-corrected data input from the outside; and
a frame memory arranged between the lookup table and the data driver to store the gamma-corrected data.

2. The organic light emitting display as claimed in claim 1, wherein the at least one lookup table comprises:
a red lookup table configured to store a gamma correction value for red data;
a green lookup table configured to store a gamma correction value for green data; and
a blue lookup table configured to store a gamma correction value for blue data.

3. The organic light emitting display as claimed in claim 1, further comprising a storage unit between the at least one lookup table and the frame memory, the storage unit being configured to store data of one line and transmit the stored data to the frame memory.

4. The organic light emitting display as claimed in claim 1, wherein the data driver is configured to generate a data signal using the gamma-corrected data input from the frame memory.

5. The organic light emitting display as claimed in claim 4, wherein the data driver comprises:
a shift register unit configured to sequentially generate a sampling signal;
a sampling latch unit configured to sequentially input the gamma-corrected data when the sampling signal is output from the shift register unit;
a holding latch unit configured to input the gamma-corrected data stored in the sampling latch unit at the same time;
a digital-analog converter configured to generate a data signal using the gamma-corrected data stored in the holding latch unit; and
a buffer unit configured to transmit the data signal to the data lines.

6. The organic light emitting display as claimed in claim 1, wherein the scan lines and data lines intersect, further comprising subpixels arranged at intersections of the scan lines and the data lines.

7. The organic light emitting display as claimed in claim 1, further comprising a timing controller configured to receive the data and synchronizing signals input from the outside.

8. The organic light emitting display as claimed in claim 7, wherein the at least one look-up table and the frame memory are included in the timing controller.

9. A method for driving an organic light emitting display, the method comprising:
gamma-correcting data, input from the outside, using a gamma correction value stored in at least one lookup table;
storing the gamma-corrected data in a frame memory; and
generating a data signal using the gamma-corrected data stored in the frame memory.

10. The method for driving an organic light emitting display as claimed in claim 9, wherein gamma-correcting data includes;
gamma-correcting red data;
gamma-correcting green data; and
gamma-correcting blue data.

11. The method for driving an organic light emitting display as claimed in claim 9, further comprising:
storing the gamma-corrected data of one line in a storage unit; and
transmitting the gamma-corrected data of one line, stored in the storage unit, to the frame memory.

12. A driving system for use in driving an organic light emitting display, the device comprising:
at least one lookup table configured to store a gamma correction value, receive data from outside, and output gamma-corrected data;
a frame memory configured to store the gamma-corrected data; and
a data driver configured to generate a data signal using the gamma-corrected data stored in the frame memory.

13. The driving system as claimed in claim 12, wherein the at least one lookup table comprises:
a red lookup table configured to store a gamma correction value for red data;
a green lookup table configured to store a gamma correction value for green data; and
a blue lookup table configured to store a gamma correction value for blue data.

14. The driving system as claimed in claim 12, further comprising a storage unit between the at least one lookup table and the frame memory, the storage unit being configured to store data of one line and transmit the stored data to the frame memory.

15. The driving system as claimed in claim 12, further comprising a timing controller configured to receive the data and synchronizing signals input from the outside.

16. The driving system as claimed in claim 15, wherein the at least one look-up table and the frame memory are included in the timing controller.

17. The driving system as claimed in claim 12, wherein the data driver comprises:
a shift register unit configured to sequentially generate a sampling signal;
a sampling latch unit configured to sequentially input the gamma-correct data when the sampling signal is output from the shift register unit;
a holding latch unit configured to input the gamma-corrected data stored in the sampling latch unit at the same time;
a digital-analog converter configured to generate a data signal using the gamma-correct data stored in the holding latch unit; and
a buffer unit configured to transmit the data signal to the data lines.

18. The driving system as claimed in claim 12, further comprising a scan driver configured to sequentially supply a scan signal to scan lines during every subframe period.
